(19) United States
(12) Patent Application Publication
(10) Pub. No.: US 2009/0238027 A1
(43) Pub. Date: Sep. 24, 2009

(54) Apparatus for and Method of Kneading Rubber Material

(75) Inventors: Yoichi Yamaguchi, Kanagawa-ken (JP); Masashi Kida, Kanagawa-ken (JP); Kazuo Miyasaka, Kanagawa-ken (JP); Syunsuke Maruyama, Kanagawa-ken (JP); Kenzuo Ogura, Mie (JP); Takehisa Morimoto, Kanagawa-ken (JP); Hideki Ishida, Kanagawa-ken (JP); Yuuichirou Hisada, Kanagawa-ken (JP); Hirohumi Immura, Kanagawa-ken (JP); Hidenori Hirai, Kanagawa-ken (JP); Masahiro Kurosawa, Kanagawa-ken (JP)

Correspondence Address: GREER, BURNS & CRAIN, 300 S WACKER DR, 25TH FLOOR, CHICAGO, IL, 60606, US

(73) Assignee: THE YOKOHAMA RUBBER CO., LTD., Tokyo (JP)

(21) Appl. No.: 11/664,644

(22) PCT Filed: Oct. 18, 2005
(86) PCT No.: PCT/JP05/19097

§ 371 Date: May 19, 2009

(30) Foreign Application Priority Data
Oct. 19, 2004 (JP) 2004-304149
Oct. 19, 2004 (JP) 2004-304153
Mar. 30, 2005 (JP) 2005-097628

(51) Int. Cl. B29B 7/56; B29B 7/68; B29B 7/72

(52) U.S. Cl. 366/73; 366/77

(57) ABSTRACT

Disclosed are: an apparatus for kneading a rubber material which continuously performs a series of processes which are kneading a rubber material with a non-vulcanization compounding agent at the beginning, kneading it with a vulcanization compounding agent, and finally obtaining final kneaded rubber; and a kneading method using this kneading apparatus. Preparatory kneaded rubber having been kneaded in one internal mixer is selectively fed, by a distribution conveyor, to a group of kneading lines where at least two kneading lines are provided to be arranged side by side. Each of the kneading line consists of a plurality of open roll mixers serially connected with each other. Intermediate kneaded rubber resulted in having a target viscosity after having been kneaded in the group of kneading lines is kneaded with a vulcanization compounding agent, whereby final kneaded rubber is obtained.

### TECHNICAL FIELD

The present invention relates to an apparatus for kneading a rubber material and a method of kneading a rubber material, and more specifically, relates to an apparatus for kneading a rubber material which, regardless of an amount of a rubber material, a kind of a compounding agent, and a compounding ratio, can generally perform kneading which is excellent in productivity, and a method of kneading a rubber material whereby kneaded rubber stable in viscosity is obtained by using this kneading apparatus.

### BACKGROUND ART

Conventionally, a rubber material before vulcanization, which is intended to be used as a material for rubber products such as a tire, has been needed to be turned into kneaded rubber having charged material uniformly kneaded therein and having a viscosity thereof reduced to a certain level, in the following manner. Kneading of raw rubber, such as natural rubber, with a compounding agent, such as carbon black, is performed while predetermined amounts thereof are charged in an internal mixer called a Banbury mixer.

However, because of such causes as heat generated by friction during the kneading operation, a temperature of the kneaded rubber extremely increases before the kneaded rubber reaches a target viscosity, and this leads to quality degradation in the kneaded rubber. Therefore, due to a restriction in terms of upper-limit temperature, it has been difficult to make the kneaded rubber to reach a target viscosity only with a one-time kneading operation. For this reason, after the kneaded rubber taken out from the internal mixer once is cooled, it is needed to be re-charged into the internal mixer to repeatedly execute plural times of kneading operations. As a result of this, a vast amount of energy has been wasted, and this has been a cause of productivity reduction.

To solve problems of this kind, a variety of methods where kneading is performed by serially arranging a multiple number of roll mixers in an internal mixer have been proposed (refer to Patent Documents 1 and 2, for example). However, in the abovementioned conventional methods, there is a disadvantage that the methods cannot correspond to all of differences in terms of amount of a rubber material, kind of a compounding agent, a compounding ratio and the like. For example, in a case of obtaining kneaded rubber which is low in compounding ratio, there has been a problem that it required a very long time to obtain the final kneaded rubber, and in a case of kneading a compounding agent which is not easily kneaded with a rubber material, there has been a problem that a large amount of the compounding agent cannot be consecutively kneaded at one time.

Additionally, in a conventional kneading apparatus, a mixer which kneads raw rubber and a non-vulcanization compounding agent is separated from a final mixer which performs kneading with a vulcanization compounding agent charged therein. For this reason, an intermediate cooling period until kneaded rubber discharged from the first mixer is charged to the final mixer is variable, it has been difficult to obtain kneaded rubber having stable quality.

Patent Document 1: Japanese patent application Kokai publication No. Sho63-56407
Patent Document 2: Japanese patent No. 2936348

### DISCLOSURE OF THE INVENTION

A main object of the present invention is to provide an apparatus for kneading a rubber material which, regardless of an amount of a rubber material, a kind of a compounding agent, and a compounding ratio, can generally perform kneading, and which is excellent in productivity. Another object of the present invention is to provide a method of kneading a rubber material which, in a case of kneading a rubber material by using the above kneading apparatus, makes it possible to stabilize viscosity of the kneaded rubber under kneading conditions of the same batch, and furthermore, to obtain stable quality without variations in viscosity even among a plurality of batches.

An apparatus for kneading a rubber material of the present invention for achieving the above object is characterized in: that, while at least one internal mixer for kneading a rubber material with a non-vulcanization compounding agent is arranged to an upstream side of a group of at least two kneading lines provided to be arranged side by side, one final mixer for kneading intermediate kneaded rubber, which is discharged from the group of kneading lines, and a vulcanization compounding agent is arranged to a downstream side of the group of kneading lines; that measuring means, and distribution means for distributing preparatory kneaded rubber, which is measured by the measuring means, to at least one kneading line of the group of kneading lines by selectively moving thereto are arranged between the internal mixer and the group of kneading lines; and that conveyance means for conveying the intermediate kneaded rubber to the final mixer is arranged between the group of kneading lines and the final mixer. In each line of the kneading lines, at least two open roll mixers are serially connected with each other, each of the open roll mixers being provided with: a pair of kneading rolls; a rekneading conveyor; and a delivery conveyor.

This kneading apparatus includes a group of at least two kneading lines provided to be arranged side by side in each line of which at least two open roll mixers are serially connected with each other, whereby it becomes possible to feed, in accordance with kneading conditions such as an amount of the preparatory kneaded rubber, a kneading period and the like, to any kneading line selected from the plurality of kneading lines, the preparatory kneaded rubber being measured by measuring means after having been discharged from the internal mixer. Thereby, final kneaded rubber can be obtained with high productivity in compliance with the kneading conditions.

Additionally, a method of kneading a rubber material of the present invention is characterized in, by using the above described kneading apparatus, kneading preparatory kneaded rubber in a manner that, in the kneading lines of the roll mixer, while a roll gap of the pair of kneading rolls is set in a range of 0.5 to 3.5 mm, a temperature of the kneaded rubber is controlled to be in a range of 40 to 90° C., the preparatory kneaded rubber being discharged from the internal mixer after having been obtained by preliminarily kneading a rubber material with a non-vulcanization compound agent by the internal mixer.

According to this kneading method, by kneading the kneaded rubber while controlling the roll gap and the temperature of the kneaded rubber simultaneously in the above respective ranges, it becomes possible to impart a sufficient shearing force to the kneaded rubber to quickly reduce a viscosity thereof, and hence, to obtain intermediate kneaded rubber which uniformly and stably has a target viscosity. Thereby, not only under kneading conditions in the same batch, it becomes possible to obtain final kneaded rubber having stable and uniform quality in terms of viscosity also among a plurality of batches.

Furthermore, another method of kneading a rubber material of the present invention is characterized in, by using the above kneading apparatus, controlling, to be not less than 90° C., a temperature of preparatory kneaded rubber at the time when it is discharged into the first roll mixer of the kneading line from the internal mixer, and controlling, to be in a range of 60 to 80° C., a temperature of the kneaded rubber at the time when it is discharged into the second roll mixer of the kneading line from the first roll mixer, the preparatory kneaded rubber being discharged from the internal mixer after having been obtained by preliminarily kneading a rubber material with a non-vulcanization compound agent by the internal mixer.

According to this kneading method, since the temperature of the preparatory kneaded rubber at the time when it is charged into the first roll mixer is controlled to be not less than 90° C., it is not necessary to especially cool the preparatory kneaded rubber discharged from the internal mixer before it is charged into the first roll mixer, and the preparatory kneaded rubber can be charged as it is. For this reason, a time required for a pre-process and a loss of energy can be minimized. Additionally, since a temperature of the kneaded rubber in the first roll mixer is only required to be in the range of 60 to 80° C. at the time when the kneaded rubber is discharged therefrom to the second roll mixer, it becomes possible to impart to the kneaded rubber a sufficient shearing force, which allows the kneaded rubber to quickly decrease in viscosity. Thereby, it becomes possible to obtain intermediate kneaded rubber which uniformly and stably has a target viscosity, and final kneaded rubber is also resulted in having stable quality.

### BRIEF DESCRIPTION OF THE DRAWINGS

FIG. 1 is a schematic configuration diagram illustrating an apparatus for kneading a rubber material of the present invention.

FIG. 2 is a schematic plan view of FIG. 1.

FIG. 3 is a cross-sectional view taking along a line X-X of FIG. 1.

FIG. 4 is a diagram illustrating an outline of a roll mixer constituting a kneading line.

FIG. 5 is a control flow chart showing an example of a method of kneading a rubber material of the present invention.

FIG. 6 is a graphic chart showing an example of a process of a control according to the method of kneading a rubber material of the present invention.

FIG. 7 is a graphic chart showing controlled regions of a rubber temperature and a roll gap in the method of kneading a rubber material of the present invention.

FIG. 8 is a graphic chart showing a relation between a kneading period and a rubber temperature in a roll mixer.

FIG. 9 is a graphic chart showing a relation between a kneading period and an electric power level in a roll mixer.

FIG. 10 is a graphic chart showing a relation between a viscosity index as an estimated value and an actually measured final viscosity.

FIG. 11 is a diagram illustrating an outline of a modification example of the roll mixer.

FIG. 12 is a diagram illustrating, by showing an enlarged main portion of FIG. 11, a method of estimating a bank amount.

FIG. 13 is a graphic chart showing a relation among a bank amount, a number of times that kneaded rubber has passed through rolls, and reduction in viscosity in the roll mixer.

### BEST MODE FOR CARRYING OUT THE INVENTION

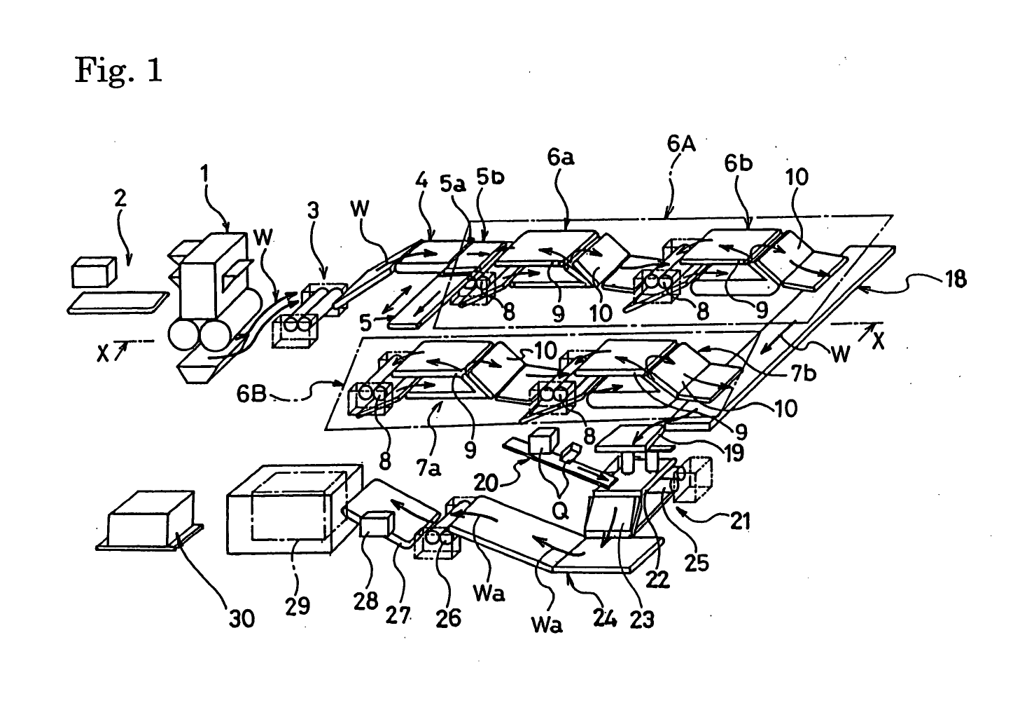

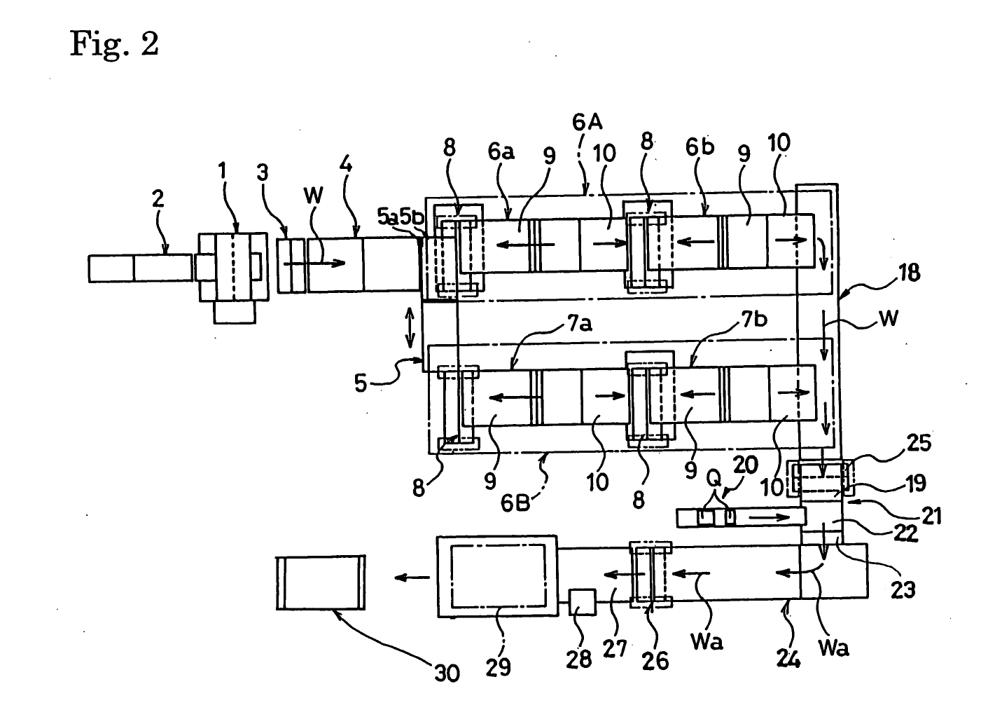

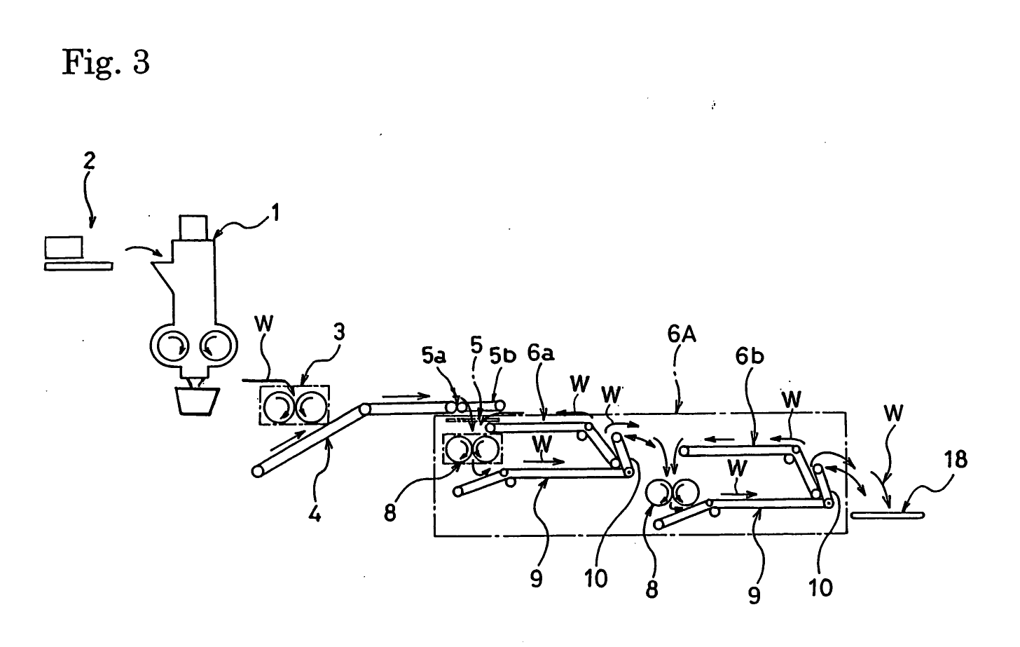

In an embodiment of an apparatus for kneading a rubber material illustrated in FIGS. 1 to 3, with one side of an internal mixer 1 called a Banbury mixer, a raw-material measuring-and-feeding unit 2 which measures and feeds raw rubber, such as natural rubber, and a non-vulcanization compounding agent, such as carbon black, is connected. In an area facing the other side of the internal mixer 1, a seating roll 3 is arranged at a specific position. The seating roll 3 is provided with a pair of kneading rolls which respectively rotate in opposite directions, whereby rubber W intended to be kneaded is allowed to pass through a clearance between the rolls.

In a discharging portion of the sheeting roll 3, a feeding conveyor 4 is arranged, and to a discharging area of this feeding conveyor 4, a distribution conveyor 5 is arranged, with a cutting unit 5a and a measuring conveyor 5b interposed therebetween, in order that the distribution conveyor 5 can be connected with the feeding conveyor 4. Two kneading lines 6A and 6B are provided side by side in order that they can be connected with the distribution conveyor 5. The distribution conveyor 5 is allowed to move between the kneading lines 6A and 6B. The kneading lines 6A and 6B are constituted of two roll mixers 6a and 6b, and other two roll mixers 7a and 7b, respectively. In each of the two roll mixers 6a and 6b, and the two roll mixers 7a and 7b, the two roll mixers are serially connected with each other in a direction orthogonal to the movement of the distribution conveyor 5. The number of roll mixers serially connected with each other is not limited to two. The number of the kneading lines, as the kneading lines 6A and 6B, arranged side by side is not limited to two, as well.

Each of the roll mixers 6a, 6b, 7a and 7b has opposing kneading rolls 8 which respectively rotate in opposite directions, and each of the roll mixers 6a, 6b, 7a and 7b has an open structure. Furthermore, each of the roll mixers 6a, 6b, 7a and 7b has a rekneading conveyor 9 forming a circulation route from downward to upward sides of the kneading rolls 8, and a delivery conveyor 10 is rotatably connected to one end portion of the rekneading conveyor 9. In a state where one side of the delivery conveyor not facing the one end of the rekneading conveyor 9 is up, rubber W passing through the kneading rolls 8 is circulated by the rekneading conveyor 9, and is repeatedly and continuously fed to the kneading rolls 8 to be kneaded. In a state where the foregoing one side of the delivery conveyor 10 is down, rubber W intended to be kneaded is transported to a subsequent step by the delivery conveyor 10.

On a transport destination side of the kneading lines 6A and 6B, an intermediate transport conveyor 18 is connected in a manner that movement of the transport conveyor 18 follows a direction orthogonal to a direction of the transport. To a transport ending portion of the intermediate transport conveyor 18, a final mixer 21, which is provided with a feeding unit 20 for a vulcanization compounding agent Q, is connected with a feeding conveyor 19 interposed therebetween. The final mixer 21 is formed as an open roll mixer provided with a pair of kneading rolls 25, a rekneading conveyor 22 and a delivery conveyor 23.

To a discharging portion of the final mixer 21, a final transport conveyor 24 is connected in a manner that movement of the final transport conveyor 24 follows a direction orthogonal to a direction of the discharging. To a transport destination side of the final transport conveyor 24, a product stock process 30 is connected with a sheeting roll 26, a transport conveyor 27, a sampling unit 28, and a cooling unit 29 interposed therebetween.

A method of kneading a rubber material by using this kneading apparatus is as follows. Note that, in the following description, rubber in phases prior to completion of kneading thereof from the internal mixer 1 to the kneading lines 6A and 6B is defined as preparatory kneaded rubber W. Additionally, rubber which has been completed with the kneading in the kneading lines 6A and 6B and is in phases prior to completion of kneading thereof in the final mixer 21 is defined as intermediate kneaded rubber W, and rubber having been completed with the kneading in the final mixer 21 is defined as final kneaded rubber Wa.

After raw rubber, such as natural rubber, and a non-vulcanization compounding agent, such as carbon black, are measured by a raw-material measuring-and-feeding unit 2, these are fed to the internal mixer 1 and then uniformly kneaded to be preparatory kneaded rubber W. This preparatory kneaded rubber W is still high in viscosity, and hence is so easy to be torn that it is not good in workability. For this reason, the preparatory kneaded rubber W is kneaded in the kneading lines 6A and 6B in the following process, whereby viscosity of the preparatory kneaded rubber W is reduced to a target viscosity to obtain intermediate kneaded rubber W.

The preparatory kneaded rubber W is kneaded by the sheeting roll 3 to be able to have a temperature not more than a predetermined temperature and to be in a sheet form, and is transported to the feeding conveyor 4. Then, the preparatory kneaded rubber W is moved from the feeding conveyor 4 to be mounted onto a measuring conveyor 5b after passing through a cutting unit 5a.

On the measuring conveyor 5b, the preparatory kneaded rubber W is measured, and, in accordance with the measured amount and kneading conditions such as a time period for the kneading, selected is whether the preparatory kneaded rubber W is going to be kneaded in one kneading line, that is, the kneading line 6A, or to be kneaded in two kneading lines, that is, the kneading lines 6A and 6B. In the case of kneading it in the one kneading line 6A, the preparatory kneaded rubber W on the measuring conveyor 5b is directly fed to only the kneading line 6A.

In the case of kneading it in the two kneading lines 6A and 6B, the preparatory kneaded rubber is evenly divided into two by the cutting unit 5a, and each portion of the divided kneaded rubber is fed to the respective kneading lines 6A and 6B with a time difference generated by using the measuring conveyor 5b and the distribution conveyor 5. When feeding the preparatory kneaded rubber W to the one kneading line 6B of these two, the distribution conveyor 5 moves toward the kneading line 6B.

Note that, in a case where there are three or more kneading lines as the kneading lines 6A, 6B and so on, portions of the preparatory kneaded rubber W divided into a predetermined ratio by the cutting unit 5a are sequentially fed to the kneading lines 6A, 6B and so on.

The respective portions of the preparatory kneaded rubber W respectively fed to the kneading lines 6A and 6B are repeatedly kneaded by the first roll mixers 6a and 7a, and subsequently, are repeatedly kneaded by the second roll mixers 6b and 7b. These kneading processes are controlled in order that a rubber temperature T in the process in the second roll mixers 6b and 7b can be sequentially reduced by 10° C. from that in the process in the first roll mixers 6a and 7a. The kneading method in detail will be described later.

By the kneading lines 6A and 6B, the respective portions of the intermediate kneaded rubber having reached a target viscosity are moved to be mounted on the intermediate transport conveyor 18 which is provided so as to be arranged to move in a direction orthogonal to a discharging direction of the kneading lines 6A and 6B. Subsequently, the respective portions of the intermediate kneaded rubber W are fed from the intermediate transport conveyor 18 to the final mixer 21 through the feeding conveyor 19, and are integrated in the final mixer 21. In the final mixer 21, a vulcanization compounding agent Q, which is measured to satisfy a certain ratio in relation to a weight of the materials charged into the internal mixer 1, is charged into a charging unit 20 to be kneaded with the intermediate kneaded rubber W.

The final kneaded rubber Wa, which has been uniformly kneaded after the vulcanization compounding agent is charged, is discharged to the final transport conveyor 24. The final kneaded rubber Wa transported by the final transport conveyor 24 is fed to the product stock process 30 through the sheeting roll 26, the transport conveyor 27, the sampling unit 28, and the cooling unit 29. In the sampling unit 28, the final kneaded rubber Wa is sampled and a quality check thereon is performed. Then, the final kneaded rubber Wa satisfying a predetermined quality level is stocked to the product stock process 30.

As described hereinabove, according to the kneading apparatus, a series of processes from charging of the rubber material and the like to obtainment of the final kneaded rubber Wa can be sequentially performed at one time. Additionally, in accordance with kneading conditions such as a weight of the material kneaded in the internal mixer 1, that is, an amount of the preparatory kneaded rubber W, a kind of the compounding agent, a compounding ratio and a kneading period, the preparatory kneaded rubber W is divided into a predetermined ratio. Then, the respective divided portions of the preparatory kneaded rubber W can be kneaded to reach a target viscosity by the kneading line 6A and 7A. The kneading thus generally excellent in productivity in response to a variety of kneading conditions makes it possible to obtain the intermediate kneaded rubber W and eventually obtain the final kneaded rubber Wa.

Consequently, even in a case of kneading the preparatory kneaded rubber in an amount impossible to be kneaded in one kneading line, or in a case where a predetermined time cycle requires a kneading period otherwise too short for kneading to be completed, it becomes possible to easily obtain a predetermined amount of the intermediate kneaded rubber W having a target viscosity in the predetermined time cycle.

Additionally, since a number of internal mixers, such as the internal mixer 1, installed can be minimized, large equipment expenditure and space can be reduced.

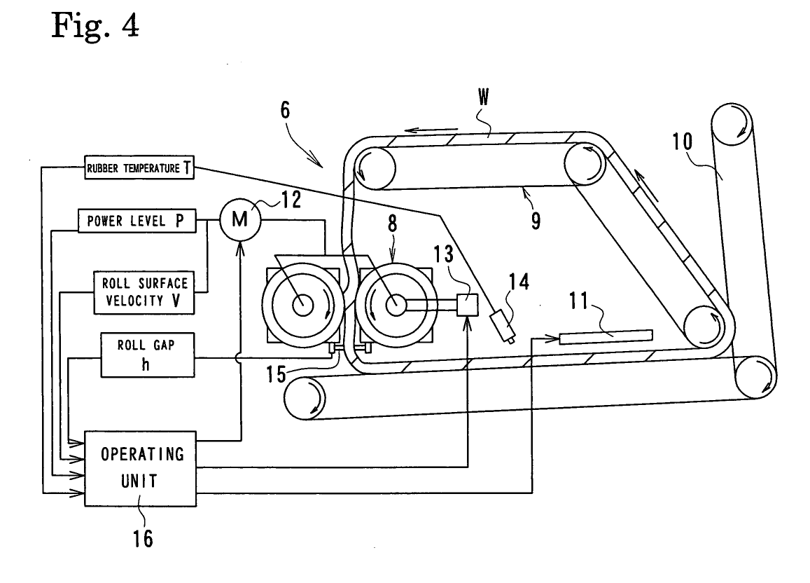

As each of the roll mixers 6a, 6b, 7a and 7b consisting of the kneading lines 6A and 6B, for example, a roll mixer 6 shown in FIG. 4 can be used. This roll mixer 6 includes a pair of kneading roils 8 which are driven to rotate in opposite directions by an electric motor 12, and are provided with a rekneading conveyor 9 and a delivery conveyor 10. The basic structure thereof is the same as that of the roll mixers 6a, 6b, 7a and 7b as described previously.

One roll of the kneading rolls 8 is provided with an actuator 13, which enables the one roll 8 to move so that it is made possible to adjust a gap (roll gap) between the rolls 8. Below the kneading rolls 8, a roll gap sensor 15 is arranged. In addition, a temperature sensor 14 which detects a temperature of the preparatory kneaded rubber W having passed through the kneading rolls 8, and a cooling fan 11 which cools the preparatory kneaded rubbers W are provided. The structure thereof is that data on a power level P (driving torque) of the electric motor 12, data on a roll surface velocity V, data on a roll gap h, and data on a rubber temperature T are transmitted to an operating unit 16.

In a case of using the roll mixer 6 as each of the first roll mixers 6a and 7a which provide the earliest kneading respectively in the kneading lines 6A and 6B, the kneading is performed as follows. When the preparatory kneaded rubber W fed from the distribution conveyor 5 is kneaded, the roll gap h is detected by the roll gap sensor 15, and the roll gap h is controlled by the actuator 13 to be between 0.5 mm and 3.0 mm inclusive. In addition, the rubber temperature T of the preparatory kneaded rubber W is detected by the temperature sensor 14, and a degree of cooling is adjusted by the cooling fan 11 in order to control the rubber temperature T to be between 40° C. and 90° C. inclusive. With these conditions, the preparatory kneaded rubber W is repeatedly kneaded. These controls are executed by the operating unit 16.

This controlled range is illustrated as the inside of a rectangle in FIG. 7. If the roll gap h is less than 0.5 mm, an amount of rubber which can be kneaded in a predetermined time period cannot be increased, and additionally, the control on the roll gap h becomes difficult. On the other hand, if the roll gap h exceeds 3.0 mm, a sufficient shearing force cannot be imparted to the preparatory kneaded rubber W, and hence a viscosity thereof cannot be quickly reduced.

If the rubber temperature T exceeds 90° C., even with repeated kneading, a sufficient shearing force cannot be imparted to the preparatory kneaded rubber W, and hence a viscosity thereof cannot be reduced. On the other hand, if the rubber temperature T is less than 40° C., loading onto the kneading rolls 8 and the like becomes large, whereby there are brought about such problems: that mechanical strength becomes insufficient; and that a risk of causing a trouble is increased because a rubber sheet becomes more likely to be torn due to decreased flowability of the preparatory kneaded rubber W.

Therefore, by performing the kneading performed by simultaneously controlling the roll gap h and the rubber temperature T respectively to be in the above ranges, it becomes possible to stably impart the sufficient shearing force to the preparatory kneaded rubber W and hence to quickly make it be reduced in viscosity. Thereby, under kneading conditions of the same batch, the intermediate kneaded rubber uniform and stable with respect to a target viscosity can be obtained. Variations in viscosity among a plurality of batches are diminished, whereby the final kneaded rubber Wa having stable and uniform quality can be obtained.

In the controlled range illustrated as the inside of a rectangle in FIG. 7, if the roll gap h and the rubber temperature T are controlled particularly in a range illustrated as the inside of a parallelogram therein, reduction in viscosity of the preparatory kneaded rubber W can be progressed still more quickly.

In another kneading method, the preparatory kneaded rubber W fed by the distribution conveyor 5 is charged to the first roll mixers 6a and 7a in a state where the preparatory kneaded rubber W has a temperature not less than 90° C. In this case, the temperature T of the preparatory kneaded rubber W discharged from the internal mixer 1 is approximately between 90° C. to 170° C. inclusive. Then, the rubber temperature T at the time when the preparatory kneaded rubber W is discharged after it has been kneaded in these roll mixers 6a and 7a is controlled to be between 60° C. and 80° C. inclusive.

In this method, it is not required to particularly cool the preparatory kneaded rubber W, which is discharged from the internal mixer 1, before it is charged into the first roll mixers 6a and 7a, and it is only required to charge it as it is. Accordingly, a time period for a pre-process and a loss of energy, which are required for it to be charged into the roll mixers 6a and 7a, can be minimized. Furthermore, because the temperature T of the preparatory kneaded rubber W is controlled to hardly change while it is set between 60° C. and 80° C., which range is effective in viscosity reduction, it is easy to control the rubber temperature T and quick viscosity reduction is possible by giving a sufficient shearing force.

Thus, not only under kneading conditions in the same batch, the intermediate kneaded rubber W uniformly and stably having a target viscosity can be obtained also in a plurality of batches, and by extension, the final kneaded rubber Wa having uniform quality can be obtained.

In this case, if the roll gap h is set between 0.5 mm and 3.0 mm inclusive, it becomes possible to further accelerate the viscosity reduction of the preparatory kneaded rubber W.

In a case of using the roll mixer 6 as each roll mixer of the first and second roll mixers 6a and 6b serially connected with each other in the kneading line 6A, and the first and second roll mixers 7a and 7b serially connected with each other in the kneading line 6B, the kneading lines 6A and 6B being arranged side by side, the kneading is performed as follows. As in the case with the above method, the preparatory kneaded rubber W discharged from the internal mixer 1 and then fed by the distribution conveyor 5 is charged to the first roll mixers 6a and 7a in a state the rubber temperature T thereof is not less than 90° C. Then, the rubber temperature T at the time when the preparatory kneaded rubber W is discharged after it has been kneaded in the first roll mixers 6a and 7a is controlled to be between 60° C. and 80° C. inclusive.

The preparatory kneaded rubber W, with the temperature thereof being kept as it is, is charged into the second roll mixers 6b and 7b by the delivery conveyor 10. In the second roll mixers 6b and 7b, the rubber temperature T at the time when the preparatory kneaded rubber W is discharged after having been kneaded therein is controlled to be between 40° C. and 75° C. inclusive.

Thus by continuously gradually reducing the temperature in each series of the serially connected two roll mixers 6a and 6b, and the serially connected two roll mixers 7a and 7b, the preparatory kneaded rubber W is thus kneaded in temperature ranges effective in viscosity reduction. Thereby, a sufficient shearing force is imparted thereto, so that the viscosity is quickly reduced. Accordingly, the intermediate kneaded rubber W having a target viscosity can be obtained.

Thus, not only under kneading conditions in the same batch, the intermediate kneaded rubber W uniformly and stably having a target viscosity can be obtained also in a plurality of batches, and by extension, the final kneaded rubber Wa having uniform quality can be obtained.

In this case as well, if the roll gap h is set between 0.5 mm and 3.0 mm inclusive, it becomes possible to further accelerate the viscosity reduction of the preparatory kneaded rubber W.

Viscosity control on the mixing by the roll mixer 6 is performed during the mixing, in order that the target viscosity can be reached in a predetermined time period, by performing a calculation to chronologically estimate a viscosity on the basis of the rubber temperature T, a driving torque, a roll gap h and a roll surface velocity V of the mixing rolls 8. In a kneading operation process, while a formula used to estimate a rubber viscosity is not particularly limited, the following formula (1) can be presented as an example:

η_{MV}=P/[K·exp[Ea/R(1/T−1/373)]·(V/2h)^{A}], (1)

where η_{MV} denotes a viscosity index (defined by setting a reference temperature to 100° C., and a shearing velocity to 2[1/s]); P, a power level of a roll drive (corresponding to the driving torque); K, a coefficient; Ea, activation energy; R, a gas constant; T, a rubber temperature; V, a roll surface velocity; h, a roll gap; and A, 0.3 to 1.0 (a coefficient determined by kneaded rubber).

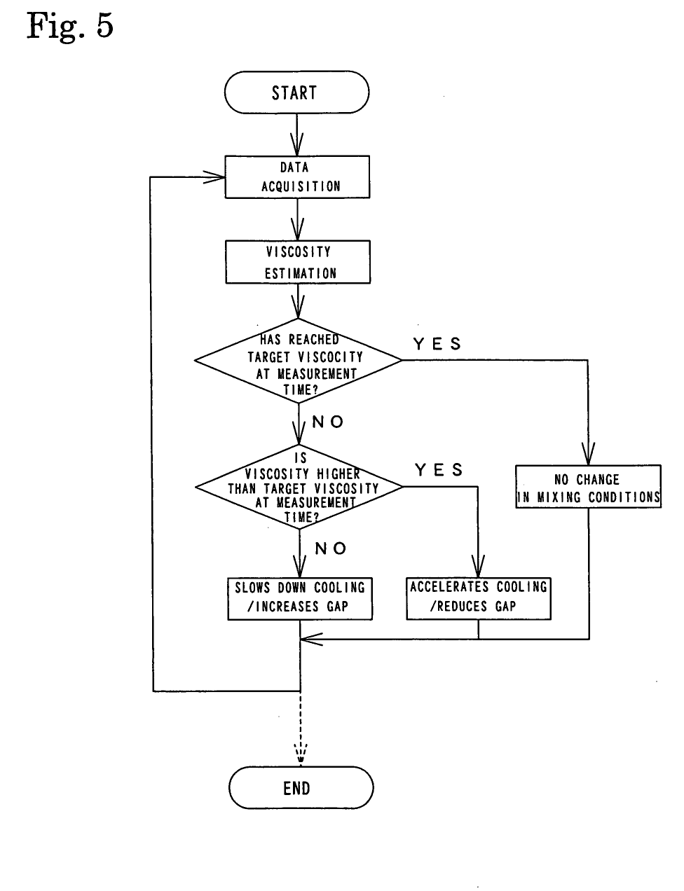

This control flow is illustrated in FIG. 5, and will be described based on this drawing. First, at a certain point of time when the preparatory kneaded rubber W has been kneaded by the roll mixer 6a to a certain extent, data on a power level P (driving torque) of the electric motor 12, the data on the roll surface velocity V, the data on the roll gap h and the data on the rubber temperature T are respectively obtained, and, by using the formula (1), the operating unit 16 estimates a viscosity of the preparatory kneaded rubber W.

Afterward, a comparison is made between a target viscosity predetermined for that certain point of time and the estimated viscosity, and if the estimated viscosity is within an allowable range of the target viscosity, the kneading is simply continued without changing the kneading conditions. If the estimated viscosity is higher than the target viscosity, cooling by the cooling fans 11 is made stronger by such a way as increasing the number of cooling fans 11, or speeding up a rotation speed of the fans, so that the rubber temperature T is decreased to accelerate viscosity reduction. It is also possible to accelerate the viscosity reduction by making the roll gap h smaller.

If the estimated viscosity is lower than the target viscosity, cooling by the cooling fans 11 is made weaker by such a way as decreasing the number of cooling fans or slowing down a rotation speed of the fans, or otherwise, cooling itself is discontinued, so that the rubber temperature T is prevented from decreasing to suppress viscosity reduction. It is also possible to suppress the viscosity reduction by making the roll gap h larger.

Cooling means for the rubber temperature T is not limited to the cooling fans 11, fluid may be circulated inside each of the kneading rolls 8 to make the fluid to exchange heat. It is also possible to adjust a kneading period by controlling and changing the roll surface velocity V.

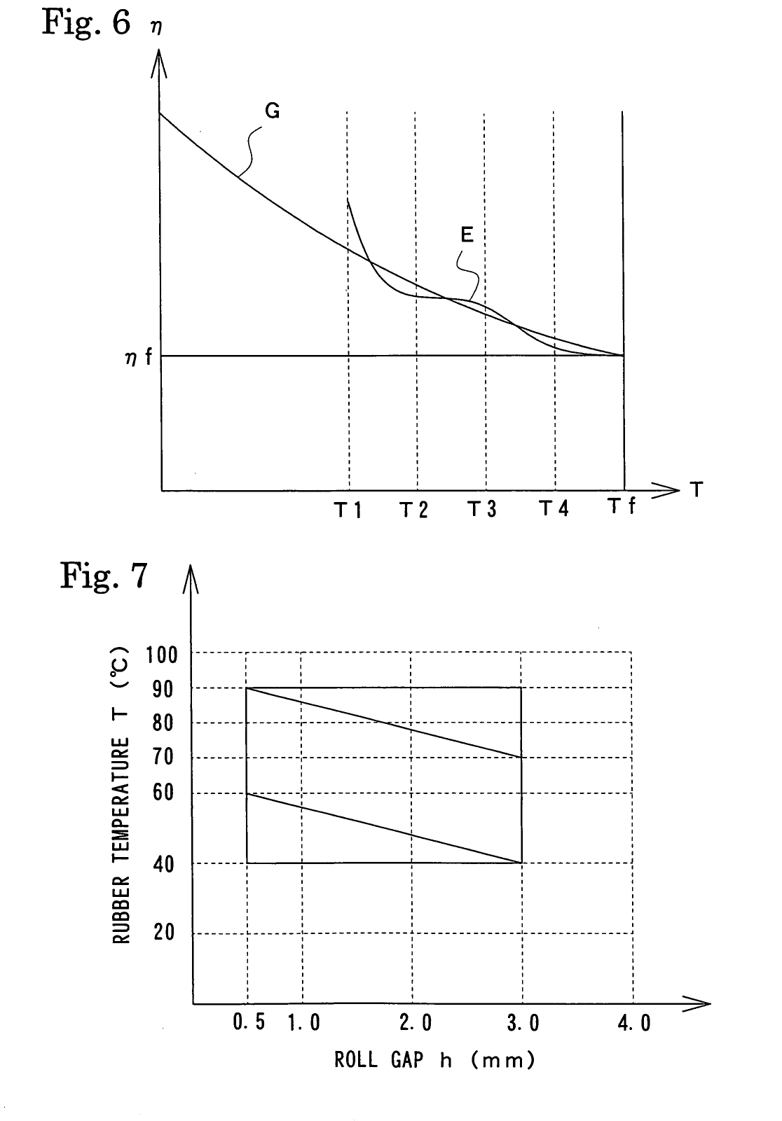

This control is repeatedly executed by an appropriately determined number of times within a predetermined kneading period. Then, at the time when the target viscosity has been obtained within the predetermined kneading period, the control is ended as indicated by a dotted line in FIG. 5. If this controlling process is graphically illustrated, that can be expressed as one in FIG. 6. Therein, this control makes viscosities E estimated at measurement times T1 to T4 to gradually come close to predetermined target viscosities G, whereby it can be a final target viscosity ηf within a predetermined kneading period Tf.

In this controlling method, when the estimated viscosities are calculated by using the above formula (1) or the like, it is preferable that, as the rubber temperature T and as the power level P (driving torque), instead of measured values which fluctuate by large amounts, estimated values be used each of which is previously set in the form of a monotonically decreasing function. A monotonically decreasing function means a functional form such as Y=A·logX+B, Y=A·expX+B, or Y=A·X^{B} (subject to X being a measured value, Y being an estimated value, and A and B being constants). Specifically, the function here is one enabled to continuously calculate an approximate curve by using the measured values, and to obtain a representative rubber temperature and representative power level (torque) at the time of measurement as estimated values. Alternatively, moving averages of the measured values in the most recent predetermined time period can be used.

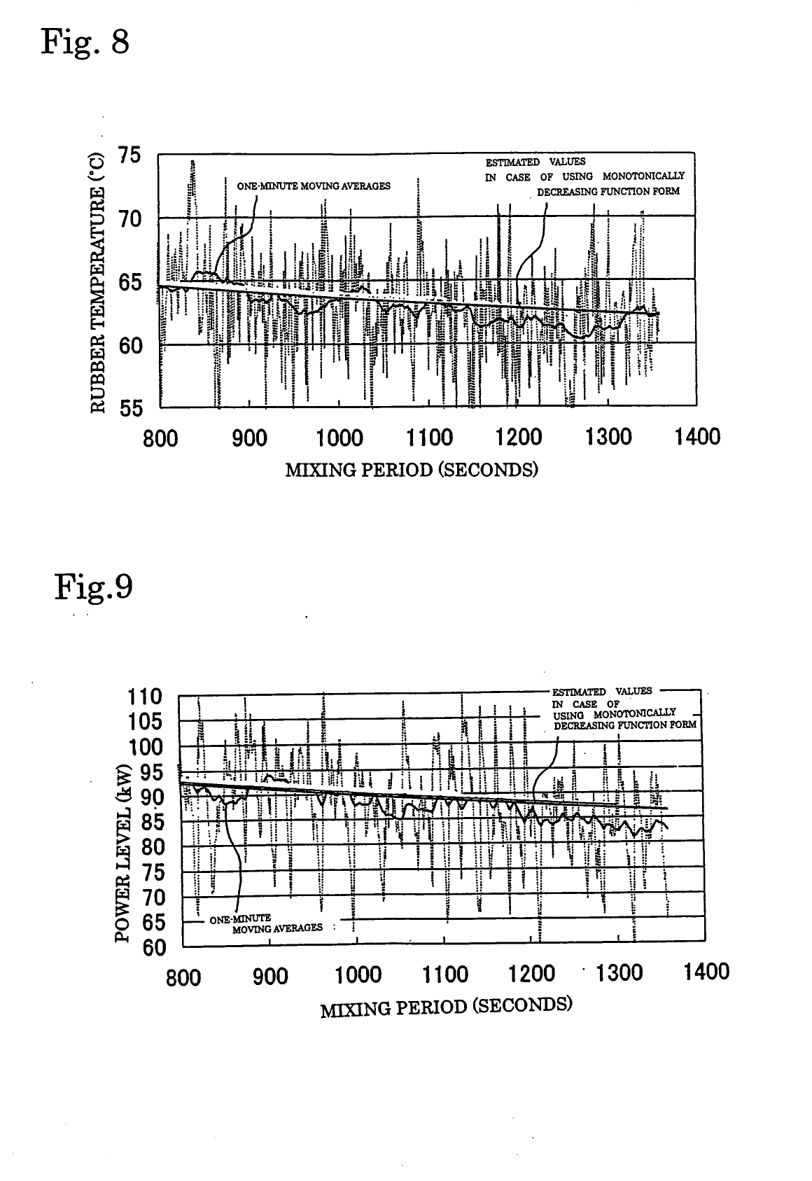

In FIGS. 8 and 9, examples of the estimated values for the rubber temperature T and the power level P found respectively by using the monotonically decreasing functions are shown with measured values and one-minute moving averages of the measured values. In each of the FIGS. 8 and 9, a dotted line fluctuating widely up and down represents the measured values, a solid line fluctuating up and down represents the one-minute moving averages, and a solid inclined straight line represents estimated values. It is found that the estimated values obtained in the forms of the monotonically decreasing functions, and the one-minute moving averages stably change as compared with the measured values, and in particular, the estimated values obtained by the monotonically decreasing functions change still more stably than the moving averages.

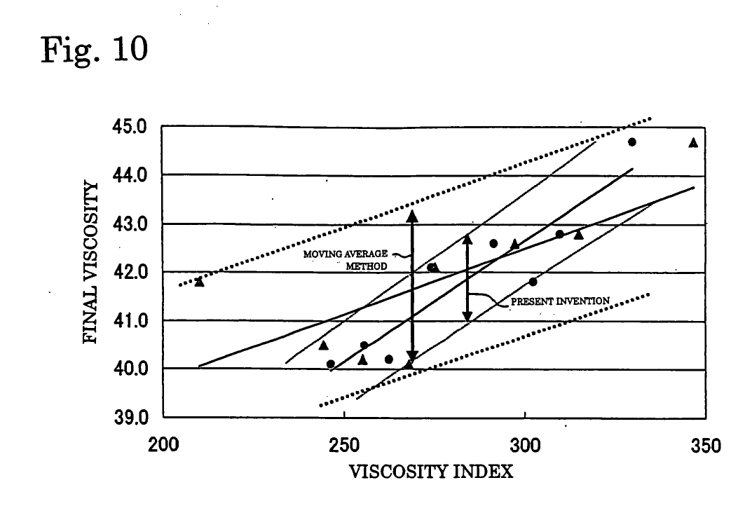

FIG. 10 shows a relation between the final viscosity index MV and a actually measured final viscosity for each of the cases: where the control is preformed by calculating estimated viscosities based on estimated values for the rubber temperature T and the power level P which are found by the monotonically decreasing functions; and where the control is performed by calculating estimated viscosities based on one-minute moving averages thereof. In FIG. 10, data plotted as solid circles show the relation in the former case with the monotonically decreasing functions, and data plotted as triangles show that in the latter case with the one-minute moving averages. Theses results mean that, in each of both of the cases, the intermediate kneaded rubber W stable and little varied in viscosity to some extent can be obtained. Particularly, according to the estimated values obtained by the monotonically decreasing functions, the relation is such that the estimated viscosities come still closer to the measured viscosities, and thus it is indicated that the intermediate kneaded rubber W stable, and little varied among batches, in viscosity can be obtained. Thereby, it also becomes possible to obtain, within a predetermined time period, the intermediate kneaded rubber W stably having a target viscosity without large non-uniformity in viscosity.

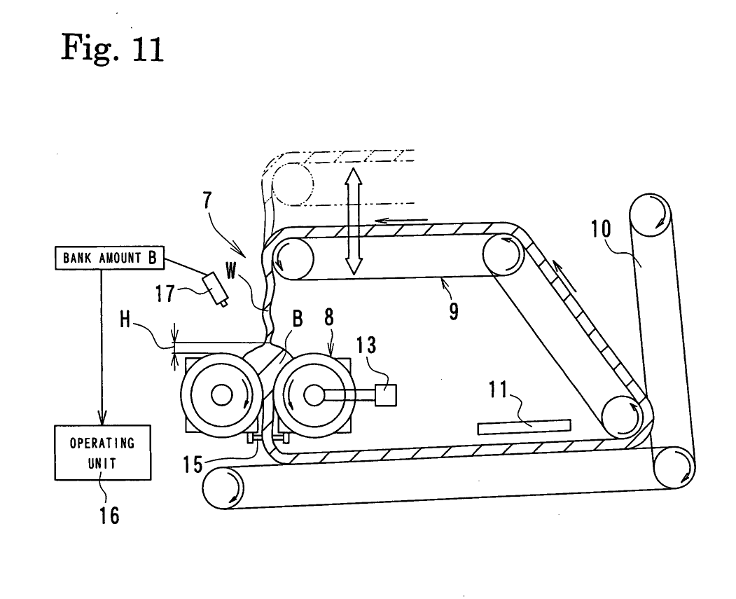

A modification example of the roll mixer 6 shown in FIG. 4 is illustrated in FIG. 11. This roll mixer 7 is obtained by adding a bank amount sensor 17 to the roll mixer 6, and, other than that, has the same structure as the roll mixer 6 has, and therefore the illustration thereof is simplified.

In the roll mixer 7, depending on a so-called bank amount B of the preparatory kneaded rubber W retained on the kneading rolls 8 during the kneading, a shearing force imparted to the preparatory kneaded rubber W is changed by the kneading rolls 8. If the bank amount B is larger, the preparatory kneaded rubber W is squeezed into a narrow clearance between the kneading rolls 8 from a wider shape, whereby a larger shearing force is imparted thereto and viscosity reduction becomes larger. Accordingly, a difference in the bank amount B causes variations in viscosity in the preparatory kneaded rubber W which is currently being kneaded.

In this roll mixer 7, for the purpose of suppressing such variations in viscosity, a bank amount sensor 17 is provided. As the bank amount sensor 17, an infrared camera, an optical sensor or the like is used to detect the bank amount B. Specifically, for example, a height H from a top face of the kneading rolls 8 to a top face of the preparatory kneaded rubber W on the kneading rolls 8, and the like, are detected, and the thus detected data is inputted into and processed in the operating unit 16 connected to the bank amount sensor 17 to estimate the bank amount B.

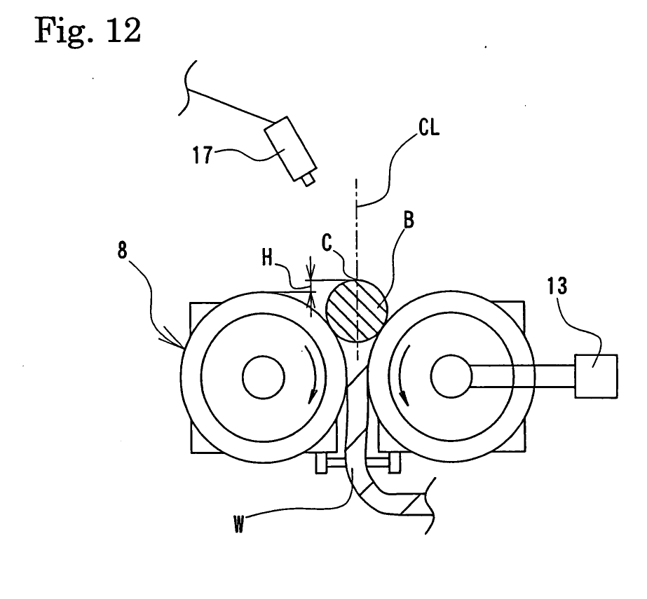

As one example of methods of estimating the bank amount B, a description will be given, based on FIG. 12, of a method of estimating it in a manner that the bank amount B is approximated as a column body. A line segment CL in FIG. 12 is a centerline located in the center of the pair of kneading rolls 8.

The height H from the top face of the kneading rolls 8 to the top face of the preparatory kneaded rubber W on the kneading rolls 8 is detected by the bank amount sensor 17. Then, an intersection C of a horizontal line, which is as high as the height H from the top face of the kneading rolls 8, and the centerline CL is calculated, and an area of a circle whose circumference passes the intersection C and contacts surfaces of the kneading rolls 8 is calculated. Subsequently, a length of the preparatory kneaded rubber W in a widthwise direction of the kneading rolls 8 is detected by the bank amount sensor 17 or other means. Then, by multiplying together the calculated area of the circle and the length of the preparatory kneaded rubber W in the widthwise direction of the rolls, a volume of the column body is found and the volume is defined as the bank amount B.

By previously having inputted data of the kneading rolls 8, such as coordinates of the centers, outer diameters and a roll gap in the operating unit 16, it becomes possible to estimate the bank amount B in a real-time basis by the operating unit 16. A method of estimating the bank amount B is not limited to this, and another method can be used to approximate the bank amount B.

When a viscosity of the rubber W currently being kneaded is higher than a predetermined viscosity, the bank amount B is controlled to be increased. In order for the bank amount B to be increased, a conveyor transport speed CV of the delivery conveyor 10 and the rekneading conveyor 9 is increased, or, a height position of the rekneading conveyor 9 is lowered to shorten a circulation passage of the preparatory kneaded rubber W.

On the other hand, when a viscosity of the preparatory kneaded rubber W currently being kneaded is lower than a predetermined viscosity, the bank amount B is controlled to be decreased. In order for the bank amount B to be decreased, the conveyor transport speed CV of the delivery conveyor 10 and the rekneading conveyor 9 may be decreased, or, a height position of the rekneading conveyor 9 may be heightened to extend a circulation passage of the preparatory kneaded rubber W.

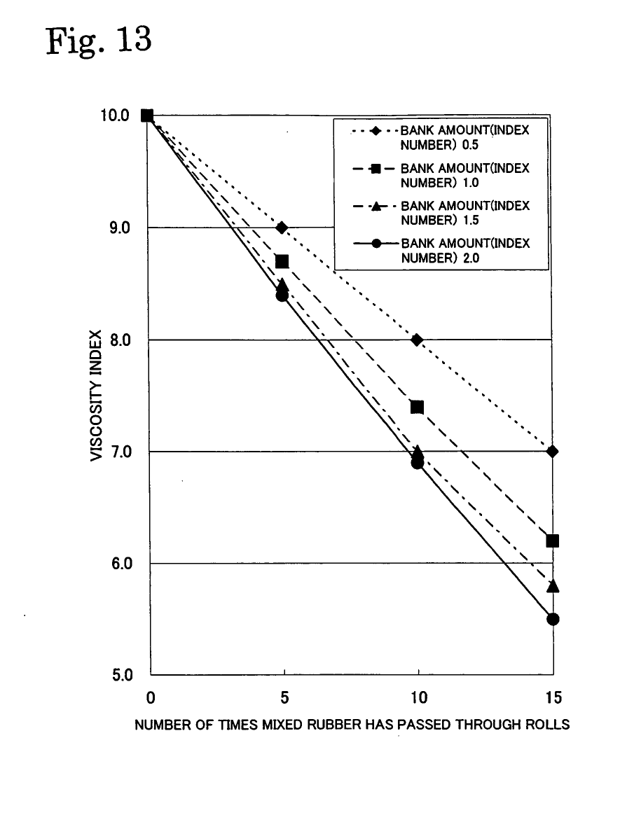

For example, viscosities in cases where roll kneading is applied to the same preparatory kneaded rubber W with only the bank amounts B made different result in those as shown in FIG. 13. The bank amount B (index number) in FIG. 13 is represented in an index number relative to a referential volume for a volume of the preparatory kneaded rubber W on the kneading rolls 8, and this index number means that the larger this index number is, the larger the bank amount B is. Specifically, in FIG. 13, the bank amounts B plotted respectively as a rhombus, as a square, as a triangle, and as a circle are larger in this order. The viscosity index is an index relative to a referential viscosity, which means that the larger the index is, the higher the viscosity is, and the rubber W is set to have 10 in the viscosity index before the roll kneading (when kneaded rubber has passed through the rolls a zero time).

By observing these results, it is found that the larger the bank amount B is, the more quickly the viscosity can be reduced and that a difference between the cases of smaller and larger bank amounts B in the viscosity reduction effect increases with increasing number of times kneaded rubber has passed through the rolls. Relations between the bank amount B and the viscosity reduction can be previously found by collecting and storing data with these kinds of measurement having been executed, for the purpose of using them in controlling increases and decreases of the bank amount B.

Viscosity control on the mixing by this roll mixer 6a is performed during the mixing, in order that the target viscosity can be reached in a predetermined time period, by performing a calculation to chronologically estimate a viscosity on the basis of the rubber temperature T, a driving torque, a roll gap h and a roll surface velocity V of the mixing rolls 8. In a kneading operation process, for example, the following formula (2) obtained by adding a term for the bank amount B to the above formula (1) can be presented as an example of a formula to estimate rubber viscosity:

η_{MV}=P/[K·exp[Ea/R(1/T−1/373)]·(V/2h−1/B)^{A}], (2)

where B denotes a bank amount and other characters are the same as those in the formula (1).

Thus, it becomes possible to obtain the intermediate kneaded rubber W still more precisely and stably having a predetermined viscosity by detecting the bank amount B by the bank amount sensor 17 to control increases and decreases of the bank amount B based on the thus detected data, in addition to controlling a temperature of the preparatory kneaded rubber W, appropriately setting the roll gap h, and the like, for the purpose of making the preparatory kneaded rubber W to reach the predetermined viscosity. As a result, the final kneaded rubber Wa can have uniform quality stable in viscosity.

### INDUSTRIAL APPLICABILITY

The abovementioned apparatus for kneading a rubber material and method of kneading a rubber material can be effectively utilized when rubber products such as a tire are manufactured.

1. An apparatus for kneading a rubber material comprising:
one internal mixer arranged to an upstream side of a group of at least two kneading lines provided side by side, which kneads a rubber material with a non-vulcanization compounding agent, each line of the kneading lines having therein at least two open roll mixers serially connected with each other, and each of the open roll mixers being provided with a pair of kneading rolls, a rekneading conveyor, and a delivery conveyor;
one final mixer arranged to a downstream side of the group of kneading lines, which kneads intermediate kneaded rubber discharged from the group of kneading lines with a vulcanization compounding agent;
measuring means arranged between the internal mixer and the group of kneading lines;
distribution means arranged between the internal mixer and the group of kneading lines, which distributes, by selectively moving among the kneading lines, to at least one kneading line of the group of kneading lines, preparatory kneaded rubber measured by the measuring means; and
transport means, arranged between the group of kneading lines and the final mixer, which transports the intermediate kneaded rubber to the final mixer.

2. The apparatus for kneading a rubber material according to claim 1, wherein the final mixer further comprises a pair of kneading rolls, a rekneading conveyor, and a delivery conveyor.

3. The apparatus for kneading a rubber material according to any one of claims 1 and 2, wherein the measuring means includes a measuring conveyor and a cutting unit, and the distribution means includes a transport conveyor.

4. The apparatus for kneading a rubber material according to claim 3, wherein each of the open roll mixers is provided with roll gap adjusting means along with driving means for the pair of kneading rolls, and additionally provided with: a roll gap sensor; a rubber temperature sensor for a temperature of kneaded rubber; an operating unit, which controls the driving means for the kneading rolls and the roll gap adjusting means based on data detected by the roll gap sensor and the rubber temperature sensor.

5. The apparatus for kneading a rubber material according to claim 4, wherein each of the open roll mixers is further provided with cooling means for kneaded rubber, which is controlled by the operating unit.

6. The apparatus for kneading a rubber material according to claim 4, wherein, by further providing each of the open roll mixers with a bank amount sensor for a bank amount of rubber retained on the pair of kneading rolls, data detected by the bank amount sensor is inputted into the operating unit.

7. A method of kneading a rubber material using the kneading apparatus according to any one of claims 1 and 2, comprising the steps of;
preliminarily kneading a rubber material with a non-vulcanization compounding agent by use of the internal mixer; and
kneading preparatory kneaded rubber, which is discharged from the internal mixer, in at least one of the kneading lines of the roll mixers in a manner that a temperature of the kneaded rubber is controlled to be in a range of 40 to 90° C. while a roll gap of the pair of the kneading rolls is set in a range of 0.5 to 3.0 mm.

8. A method of kneading a rubber material using the kneading apparatus according to any one of claims 1 and 2, comprising the steps of;
preliminarily kneading a rubber material with a non-vulcanization compounding agent by use of the internal mixer; and
at the time when preparatory kneaded rubber, which is discharged from the internal mixer, is charged from the internal mixer into the first roll mixer in at least one of the kneading lines of the roll mixers, controlling a temperature of the preparatory kneaded rubber to be at least 90° C.; and
at the time when the kneaded rubber is discharged from the first roll miser into the second roll mixer, controlling a temperature of the kneaded rubber to be in a range of 60 to 80° C.

9. The method of kneading a rubber material according to claim 8, further comprising the step of controlling a temperature of the kneaded rubber, which has been kneaded in and is discharged from the second roll mixer, to be in a range of 40 to 75° C.

10. The method of kneading a rubber material according to claim 8, further comprising the steps of:
inputting data detected by the roll gap sensor and the rubber temperature sensor into the operating unit; and
controlling at least any one of the driving means for the kneading rolls, the roll gap adjusting means, and the cooling means based on a difference between a viscosity, which is calculated by the operating unit by way of a preset viscosity estimation formula, and a target viscosity.

11. The method of kneading a rubber material according to claim 10, further comprising the steps of:
inputting data detected by the bank amount sensor into the operating unit; and
controlling at least any one of a transport speed of the rekneading conveyor, and a position thereof based on a difference between the calculated viscosity obtained by the operating unit and a target viscosity.
